(19) United States
(12) Patent Application Publication
(10) Pub. No.: US 2025/0132962 A1
(43) Pub. Date: Apr. 24, 2025

(54) METHOD FOR DEVICE TO DEVICE COMMUNICATION

(71) Applicant: ZTE Corporation, Shenzhen (CN)

(72) Inventors: Weiqiang DU, Shenzhen (CN); Lin CHEN, Shenzhen (CN); Wei LUO, Shenzhen (CN)

(21) Appl. No.: 18/990,833

(22) Filed: Dec. 20, 2024

Related U.S. Application Data
(63) Continuation of application No. PCT/CN2023/076649, filed on Feb. 17, 2023.

(51) Int. Cl. H04L 27/26; H04B 7/06; H04W 24/10

(52) U.S. Cl. CPC H04L 27/261; H04B 7/06952; H04W 24/10

(57) ABSTRACT

A wireless communication method for use in a first wireless communication device is disclosed. The method comprises transmitting, to a second wireless communication device, a beam reference signal configuration, and receiving, from the second wireless communication device, a beam reference signal measurement result associated with the beam reference signal configuration.

### CROSS-REFERENCE TO RELATED APPLICATIONS

This application is a continuation of International Patent Application No. PCT/CN2023/076649, filed on Feb. 17, 2023, the disclosure of which is incorporated herein by reference in its entirety.

### TECHNICAL FIELD

This document is directed generally to wireless communications, and in particular to 5G communications.

### BACKGROUND

With the development of wireless multimedia services, demands for high data rate and great user experience continuously increase, resulting in higher requirements of the system compacity and coverage of conventional cellular networks. On the other hand, demands for proximity services also increase because of application scenarios such as public security, social network, near-field data sharing and local advertisement. Traditionally, the cellular network using the base station as the center may have obvious limitations on supporting the high data rates and the proximity service. In order to satisfy such requirements, device-to-device (D2D) communication technology is proposed. By applying the D2D communication technology, the burden of the cellular network can be relieved, power consumption of the user equipment (UE) can be reduced and the data rate can be increased and the robustness of the network infrastructure can be improved. Thus, the demands for high data rate and proximity services are greatly satisfied. In this context, D2D communication technology is also named proximity services (ProSe) or sidelink communications, wherein an interface between the UEs is called sidelink interface.

The UE using the sidelink communications support two resource modes, i.e., mode1 and mode2. For the mode1, the UE uses resources scheduled by the network to transmit sidelink data. For the mode2, the UE selects transmission resources by itself to transmit the sidelink data.

In addition, the wireless communications are performed on carriers or frequency bands. Two different frequency ranges are available for the 5G technology including sidelink and the different ranges have been designated FR1 (frequency range 1) and FR2 (frequency range 2). The bands in the FR1 are envisaged to carry much of the traditional cellular mobile communications traffic. The higher frequency bands in the FR2 are aimed at providing short range very high data rate capability for the 5G radio. With 5G wireless technology anticipated to carry much higher speed data, the additional bandwidth of these higher frequency bands will be needed. Originally, the FR1 band was intended to define bands below 6 GHZ, but with anticipated additional spectrum allocations, the FR1 range was extended to 7.125 GHz after the WRC19 (World Radio Conference in 2019) where global spectrum allocations were agreed. Currently, the UE may be able to communicate directly with each other (i.e., without use of a base station) on the carrier within the FR1. To improve the data rate, sidelink communications may be applied on the carrier within the FR2.

When low-range and mid-range of frequency are used, a signal can be transmitted in all direction or relatively wide angles. However, when the very high frequency (e.g., the carrier in the FR2) is used, a huge antenna array may be necessary. As a result of using such huge antenna array, the resulting radiation would be a beam. The corresponding technology is called beamforming. For a device, each beam occupies a specific direction. By adopting different transmission parameter, wireless device can control the direction of the beam. However, when communicate with other device, questions of which beam should be used, whether the used beam still works well and how to select a resource for transmitting data by using the beam need to be addressed.

### SUMMARY

This document relates to methods, systems, and devices for the D2D communications, and in particular to methods, systems, and devices for the D2D communications using a carrier in a frequency range (e.g., the FR2).

The present disclosure relates to a wireless communication method for use in a first wireless communication device. The method comprises:
transmitting, to a second wireless communication device, a beam reference signal configuration, and
receiving, from the second wireless communication device, a beam reference signal measurement result associated with the beam reference signal configuration.

Various embodiments may preferably implement the following features:

Preferably, the beam RS measurement configuration include at least one of: a measurement result report threshold, a measurement result threshold for a beam recovery, or a sorting quantity.

Preferably, the sorting quantity comprises at least one of a preference level, a recommendation level, or a channel busy ratio.

Preferably, the beam reference signal measurement result is sorted based on the sorting quantity.

Preferably, the beam reference signal measurement result is sorted in an ascending order or a descending order based on the sorting quantity.

Preferably, the beam reference signal measurement result comprises at least one beam identifier.

Preferably, each beam identifier an index of a beam reference signal.

Preferably, the wireless communication method further comprises receiving, from a wireless network node, the beam reference signal configuration.

The present disclosure relates to a wireless communication method for use in a second wireless communication device. The method comprises:
receiving, from a first wireless communication device, a beam reference signal configuration, and
transmitting, from the second wireless communication device, a beam reference signal measurement result based on the beam reference signal configuration.

Various embodiments may preferably implement the following features:

Preferably, the beam RS measurement configuration include at least one of: a measurement result report threshold, a measurement result threshold for a beam recovery, or a sorting quantity.

Preferably, the sorting quantity comprises at least one of a preference level, a recommendation level, or a channel busy ratio.

Preferably, the beam reference signal measurement result is sorted based on the sorting quantity.

Preferably, the beam reference signal measurement result is sorted in an ascending order or a descending order based on the sorting quantity.

Preferably, the beam reference signal measurement result comprises at least one beam identifier.

Preferably, each beam identifier an index of a beam reference signal.

The present disclosure relates to a wireless communication method for use in a first wireless communication device. The method comprises:
determining at least one beam selection condition associated with a second wireless communication device is met, and
triggering a beam selection process for the second wireless communication device.

Various embodiments may preferably implement the following features:

Preferably, the at least one beam re-selection condition comprises at least one of:
a resource re-selection is triggered,
a beam measurement result associated with the second wireless communication device is lower than a beam re-selection threshold,
a selected beam for the second wireless communication device is within a non-preferred beam list received from the second wireless communication device,
a maximum number of consecutive hybrid automatic repeated request discontinuous transmissions has been reached, or
a maximum number of consecutive physical sidelink feedback channel absent has been reached.

Preferably, triggering the beam selection process for the second wireless communication device comprises at least one of:
determining all the beams are candidate beam,
determining the beam reported by second wireless communication device as candidate beam,
determining a first beam having a first measurement result above a beam selection threshold as a candidate beam,
excluding a second beam having a second measurement result below the beam selection threshold from the candidate beams,
excluding at least one non-preferred beam received from second wireless communication device from the candidate beams,
selecting a beam from preferred beam received from second wireless communication device
selecting a beam from recommended beam received from second wireless communication device
selecting a beam from the candidate beams,
selecting the beam from a preferred beam list received from the second wireless communication device, or
selecting the beam from at least one overlapping beam which is in the candidate beams and the preferred beam list received from the second wireless communication device.

The present disclosure relates to a wireless communication method for use in a first wireless communication device. The method comprises:
selecting a transmission resource for a sidelink communication, and
allocating the transmission resource for the sidelink communication.

Various embodiments may preferably implement the following features:

Preferably, selecting a transmission resource for the sidelink communication:
selecting a beam from at least one candidate beam and selecting the transmission resource from transmission resources associated with the selected beam, or
selecting the transmission resource from transmission resources associated with the at least one candidate beam.

Preferably, the selected transmission resource is a sidelink grant.

Preferably, allocating the transmission resource for the sidelink communication comprises:
selecting a destination wireless communication device if a beam associated with the sidelink grant is within a candidate beam list of the destination wireless communication device, or
selecting a destination wireless communication device if a measurement result of a beam associated with the sidelink grant is greater than a beam selection threshold of the destination wireless communication device, or
selecting the destination wireless communication device if the beam of the sidelink grant is within the beam list reported by the destination wireless communication device.

The present disclosure relates to a wireless communication method for use in a first wireless communication device. The method comprises:
receiving, from a third wireless communication device, a dedicated configuration associated with a standalone signaling for a sidelink communication, and
performing the sidelink communication based on the dedicated configuration.

Various embodiments may preferably implement the following features:

Preferably, performing the sidelink communication based on the dedicated configuration comprises: transmitting, to at least one peer wireless communication device, the standalone signaling.

Preferably, the standalone signaling comprises at least one of a beam reference signal, sidelink control information, or a request of beam reference signal measurement.

Preferably, the beam reference signal comprises at least one of a channel state information reference signal, a sounding reference signal, or a sidelink synchronization signal physical broadcast channel block.

Preferably, the dedicated configuration associated with the standalone signaling comprises at least one of:
a priority of the standalone signaling,
a scheduling request identifier indicating a scheduling request configuration applicable for the standalone signaling,
a logic channel identifier of the standalone signaling, or
a logic channel group of the standalone signaling.

Preferably, the wireless communication method further comprises: transmitting, to the third wireless network node, standalone signaling transmission information.

Preferably, the standalone signaling transmission information comprises at least one of:
a period of the standalone signaling,
a latency bound of the standalone signaling, or
a resource scheduling request for the standalone signaling.

Preferably, the third wireless communication device is a wireless network node.

The present disclosure relates to a wireless communication method for use in a third wireless communication device. The method comprises:
transmitting, to a first wireless communication device, a dedicated configuration associated with a standalone signaling for a sidelink communication.

Various embodiments may preferably implement the following features:

Preferably, the standalone signaling comprises at least one of a beam reference signal, sidelink control information, or a request of a beam reference signal measurement.

Preferably, the beam reference signal comprises at least one of a channel state information reference signal, a sounding reference signal, or a sidelink synchronization signal physical broadcast channel block.

Preferably, the dedicated configuration associated with the standalone signaling comprises at least one of:
a priority of the standalone signaling,
a scheduling request identifier indicating a scheduling request configuration applicable for the standalone signaling,
a logic channel identifier of the standalone signaling, or
a logic channel group of the standalone signaling.

Preferably, the wireless communication method further comprises: receiving, from the first wireless network node, standalone signaling transmission information.

Preferably, the standalone signaling transmission information comprises at least one of:
a period of the standalone signaling,
a latency bound of the standalone signaling, or
a resource scheduling request for the standalone signaling.

Preferably, the third wireless communication device is a wireless network node.

The present disclosure relates to a wireless communication method for use in a first wireless communication device. The method comprises:
determine a first communication path with a second wireless communication device is failed, and
transmitting, to the second wireless communication device, path failure information via a second communication path via a first radio bearer.

Various embodiments may preferably implement the following features:

Preferably, the first radio bearer is for the first communication path.

Preferably, determining the communication path is failed comprises:
determining a radio link failure on the first communication path is detected.

Preferably, the first communication path and/or the second communication path is a direct path or an indirect path.

Preferably, the direct path is a path on which the first communication device directly communicates with the second wireless communication device.

Preferably, the indirect path is a path on which the first communication device communicates with second wireless communication device via a third communication device.

Preferably, transmitting, to the second wireless communication device, the path failure information via the first radio bearer comprises at least one of:
changing a bearer type of the first radio bearer from a direct bearer to an indirect bearer,
changing the bearer type of the first radio bearer from the indirect bearer to the direct bearer,
applying a default radio link control (RLC) configuration for the first radio bearer, or
applying a default sidelink RLC configuration for the first radio bearer.

Preferably, the first radio bearer is a signaling radio bearer.

The present disclosure relates to a wireless communication method for use in a first wireless communication device. The method comprises:
receiving, from a second wireless communication device, channel occupancy time (COT) sharing information including a shared, and
determining a resource re-selection is triggered in response to at least one of:
a selected transmission resource for communicating with the second wireless communication device is not within the shared COT included in the COT sharing information,
all selected transmission resources for communicating with the second wireless communication device is not within the shared COT,
any selected transmission resources for communicating with the second wireless communication device is not within the shared COT, or
the candidate resource is available and the candidate resource is within the shared COT.

The present disclosure relates to a first wireless communication device. The first wireless communication device comprises:
a communication unit, configured to:
transmit, to a second wireless communication device, a beam reference signal configuration, and
receive, from the second wireless communication device, a beam reference signal measurement result associated with the beam reference signal configuration.

Various embodiments may preferably implement the following feature:

Preferably, the first wireless communication device further comprises a processor configured to perform any of aforementioned wireless communication methods.

The present disclosure relates to a second wireless communication device. The second wireless communication device comprises:
a communication unit, configured to:
receive, from a first wireless communication device, a beam reference signal configuration, and
transmit, from the second wireless communication device, a beam reference signal measurement result based on the beam reference signal configuration.

Various embodiments may preferably implement the following feature:

Preferably, the second wireless communication device further comprises a processor configured to perform any of aforementioned wireless communication methods.

The present disclosure relates to a first wireless communication device. The first wireless communication device comprises:
a processor, configured to:
determine at least one beam selection condition associated with a second wireless communication device is met, and
trigger a beam selection process for the second wireless communication device.

Various embodiments may preferably implement the following feature:

Preferably, the processor is further configured to perform any of aforementioned wireless communication methods.

The present disclosure relates to a first wireless communication device. The first wireless communication device comprises:
a processor, configured to:
select a transmission resource for a sidelink communication, and
allocate the transmission resource for the sidelink communication.

Various embodiments may preferably implement the following feature:

Preferably, the processor is further configured to perform any of aforementioned wireless communication methods.

The present disclosure relates to a first wireless communication device. The first wireless communication device comprises:
a communication unit, configured to receive, from a third wireless communication device, a dedicated configuration associated with a standalone signaling for a sidelink communication, and
a processor, configured to perform the sidelink communication based on the dedicated configuration.

Various embodiments may preferably implement the following feature:

Preferably, the processor is further configured to perform any of aforementioned wireless communication methods.

The present disclosure relates to a third wireless communication device. The third wireless communication device comprises:
a communication unit, configured to transmit, to a first wireless communication device, a dedicated configuration associated with a standalone signaling for a sidelink communication.

Various embodiments may preferably implement the following feature:

Preferably, the third wireless communication device further comprises a processor configured to perform any of aforementioned wireless communication methods.

The present disclosure relates to a first wireless communication device, comprising:
a processor, configured to determine a first communication path with a second wireless communication device is failed, and
a communication unit, configured to transmit, to the second wireless communication device, path failure information via a second communication path via a first radio bearer.

Various embodiments may preferably implement the following feature:

Preferably, the processor is further configured to perform any of aforementioned wireless communication methods.

The present disclosure relates to a first wireless communication device. The first wireless communication device comprises:
a communication unit, configured to receive, from a second wireless communication device, channel occupancy time (COT) sharing information including a shared, and
a processor, configured to determine a resource re-selection is triggered in response to at least one of:
a selected transmission resource for communicating with the second wireless communication device is not within the shared COT included in the COT sharing information,
all selected transmission resources for communicating with the second wireless communication device is not within the shared COT,
any selected transmission resources for communicating with the second wireless communication device is not within the shared COT, or
the candidate resource is available and the candidate resource is within the shared COT.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a flowchart diagram of two user devices communicating with each other according to an embodiment of the present disclosure.

FIG. 2 shows a flowchart diagram of two user devices communicating with each other according to an embodiment of the present disclosure.

FIG. 3 shows a flowchart diagram of two user devices communicating with each other according to an embodiment of the present disclosure.

FIG. 4 shows a flowchart diagram of two user devices communicating with each other according to an embodiment of the present disclosure.

FIG. 5 shows an example of a schematic diagram of a wireless terminal according to an embodiment of the present disclosure.

FIG. 6 shows an example of a schematic diagram of a wireless network node according to an embodiment of the present disclosure.

FIG. 7 shows an example of a network/system (architecture) according to an embodiment of the present disclosure.

FIG. 8 shows a schematic diagram of a direct path and an indirect path according to an embodiment of the present disclosure.

### DETAILED DESCRIPTION

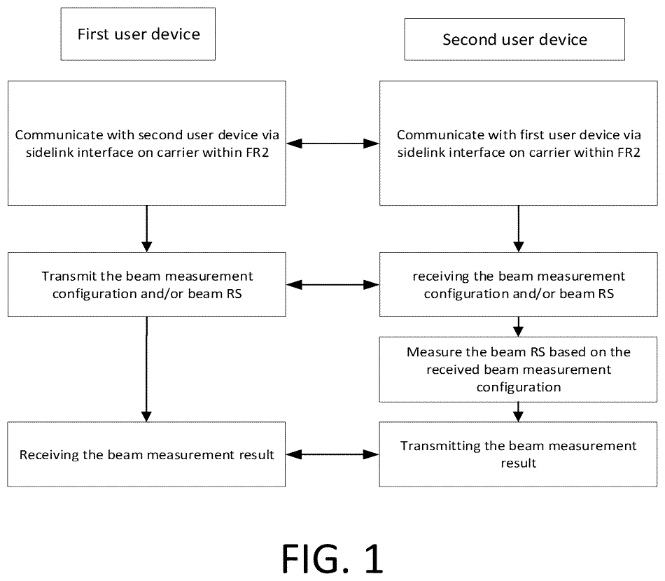

In an embodiment, the TX UE (e.g., the first user device in FIG. 1) may send a beam measurement configuration to the RX UE (e.g., the second user device in FIG. 1).

In an embodiment, the beam measurement configuration may include a beam RS configuration.

In an embodiment, the beam measurement configuration may include a sorting quantity.

In an embodiment, the beam measurement configuration may include a reporting quantity.

For example, the sorting or reporting quantity may be/comprise at least one of: a Reference Signal Receiving Power (RSRP), a Reference Signal Receiving Quality (RSRQ), Received Signal Strength Indicator (RSSI), Signal to Interference plus Noise Ratio (SINR), a preferred level, a recommendation level, a channel busy ratio, or non-preferred level.

In an embodiment, the RX UE sends beam measurement result(s) to the TX UE.

The beam measurement result can be at least one of: RSRP, RSRQ, RSSI, or SINR

In an embodiment, the beam is represented by the beam ID.

In an embodiment, the beam measurement result(s) includes at least one beam ID (identifier), where the beam ID may be an ID of a beam RS (reference signal), a beam index, an index of the beam RS.

In an embodiment, the RX UE includes the beam ID in an order of decreasing sorting quantity. For example, if the sorting quantity is preferred level and N beam IDs are included in the beam measurement result, the first (1^{st}) beam ID in the beam measurement result is the most preferred beam to be used for communication from RX UE's perspective. The last beam ID in beam measurement result is the least preferred beam to be used for communication.

In an embodiment, if the sorting quantity is non-preferred level and N beam IDs are included in the beam measurement result, the first beam ID in the beam measurement result is the most non-preferred beam to be used for communication from the perspective of the RX UE. That is the last beam ID in the beam measurement result is the least non-preferred beam to be used for the communications.

In an embodiment, the RX UE includes the beam ID in order of increasing sorting quantity. For example, if the sorting quantity is the preferred level and N beam IDs are included in the beam measurement result. The last beam ID in the beam measurement result is the most recommended beam to be used for communication from RX UE's perspective. The first beam ID in the beam measurement result is the least recommended beam to be used for communication.

In an embodiment, the beam measurement configuration may further include a measurement result report threshold. In this embodiment, the RX UE includes a beam ID in the beam measurement result if the beam measurement result of the bead corresponding to the beam ID is above the measurement result report threshold.

In an embodiment, the beam measurement result can be at least one of: RSRP, RSRQ, or SINR.

In an embodiment, the network configures the beam measurement configuration to the TX UE for the RX UE to report the beam measurement result.

In an embodiment, when detecting beam failure, the UE may trigger a beam failure recovery. In response to the beam failure recovery being triggered, the UE sends a beam failure recover signaling to the peer UE. The beam failure recovery signaling may include the beam measurement result.

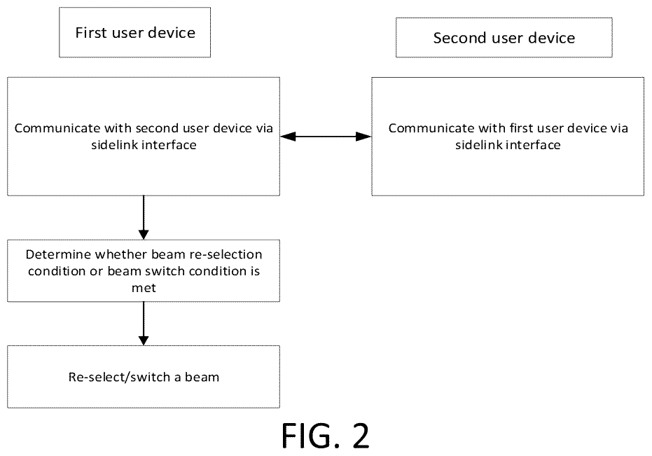

FIG. 2 shows a flowchart diagram of two user devices communicating with each other according to an embodiment of the present disclosure.

In one embodiment, due to change of channel quality, the selected beam may be not appropriate to be used for the communications. Under such conditions, the UE (e.g., TX UE or first user device shown in FIG. 2) needs to perform the beam selection again (i.e., trigger a beam re-selection (process)) to select another beam.

In one embodiment, the UE may need to select an appropriate beam from a candidate beam list for a specific destination (e.g., another UE or peer UE or second user device in FIG. 2), to ensure the quality of service (QoS) of the communications.

In one embodiment, when the UE performs the beam (re-)selection, the UE determines that all the beams are included in the candidate beam list.

In one embodiment, the peer UE may only report, to the UE, the beam(s) with measurement result(s) higher than a measurement result report threshold. In this embodiment, the UE determines the beam(s) reported by the peer UE as candidate beam.

In one embodiment, when/if the UE performs the beam (re-)selection, the UE excludes the non-preferred beam received from the peer UE from the candidate beam list.

In one embodiment, when/if the UE performs the beam (re-)selection, the UE selects a beam from a preferred beam list received from the peer UE.

In one embodiment, when/if the UE performs the beam (re-)selection, the UE selects a beam from a recommended beam list received from the peer UE.

In one embodiment, when/if the UE performs the beam (re-)selection, the UE determines the beam with the measurement result above a beam selection threshold as a candidate beam. The beam selection threshold may be received from the network. As an alternative or in addition, the beam selection threshold may be received from the peer UE.

In one embodiment, if/when UE performs the beam (re-)selection, the UE selects the beam within an intersection of the candidate beam list and the preferred beam list received from peer UE. That is the selected beam is in both the candidate beam list and the preferred beam list.

In an embodiment, for the beam (re)selection, the TX UE performs at least one of following:
Determining the beam with measurement result above the beam selection threshold is candidate beam;
Excluding the beam with measurement result below the threshold from candidate beam.
Excluding the non-preferred beam from candidate beam.
Selecting a beam from the candidate beams.
Selecting the beam from preferred beam list received from RX UE.
Selecting the beam from the overlapping the candidate beam and preferred beam received from RX UE.
Excluding the beam from candidate beam if the beam failure is detected on this beam.
Excluding the beam from candidate beam if the beam failure is complete on this beam.

In an embodiment, the beam selection threshold is configured by the network.

In an embodiment, the TX UE may trigger a beam re-selection or beam switching if at least one of the following conditions is met:
Determine beam measurement result is lower than the beam re-selection threshold.
Determine the selected beam is within the non-preferred beam list received from RX UE.
Determine that maximum number of consecutive HARQ DTX has been reached.
Determine that maximum number of consecutive PSFCH absent has been reached.
When the resource re-selection is triggered.

In one embodiment, the beam re-selection threshold is configured by the network.

In an embodiment, if the UE determines that beam re-selection is triggered, the UE triggers resource re-reselection.

In an embodiment, if the UE determines that beam switching is triggered, the UE triggers resource re-reselection.

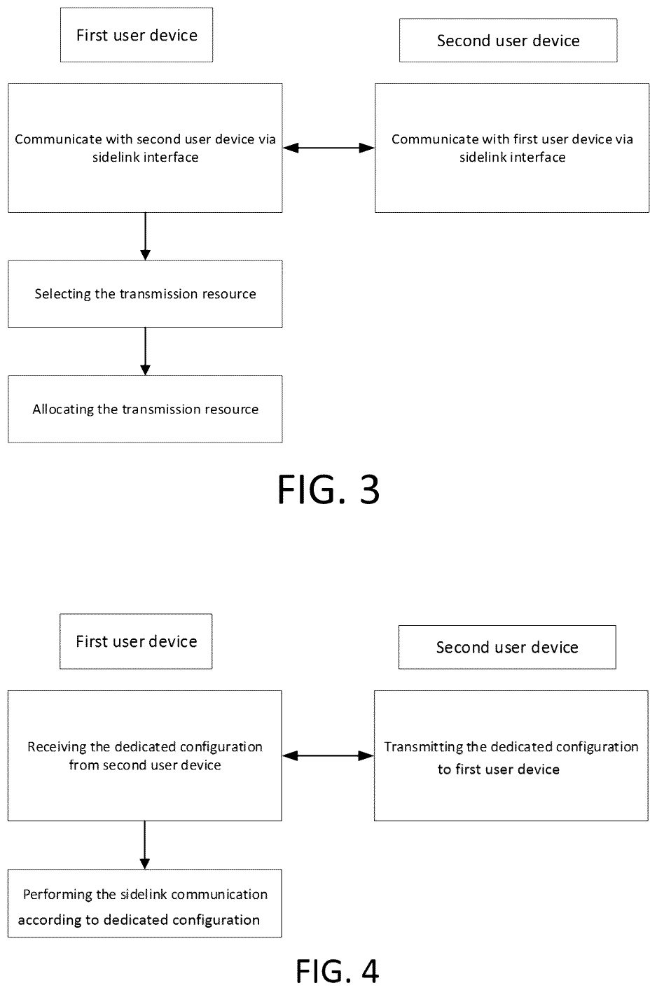

FIG. 3 shows a flowchart diagram of two user devices communicating with each other according to an embodiment of the present disclosure. In one embodiment, the RX UE may provide some resource assistance information to the TX UE, and the TX UE selects the resource according to the resource assistance information.

In one embodiment, after receiving the resource assistance information from the peer UE (e.g., RX UE or second user device shown in FIG. 3), the UE (e.g., TX UE or first user device) determines whether at least one of following condition is met:
the assistance information is located in the selected resource pool, or
the assistance information is received from the selected resource pool

If the condition is met, the UE take the assistance information into consideration during resource selection. For example, the UE selects the resource within the intersection of preferred resource set and its own sensing result.

In one embodiment, if/when the UE performs beam (re-)selection, the UE selects the beam within the intersection of the candidate beam list and the recommended beam list received from the peer UE.

The resource assistance information may include a set of resource, e.g., preferred resource, non-preferred resource. The resource assistance information may be generated by using beam forming, i.e., the RX UE may provide the resource assistance information in granularity of beam. Therefore, the resource assistance information include the beam ID. The Beam ID can be ID of beam RS. The Beam ID can be index of beam RS.

In one embodiment, it is possible that the transmission resource is associated to the beam direction, i.e., different beam may have different candidate resource set. For example, the UE has two beams with different beam directions BD1 and BD2. Based on the result of monitoring result on the different beam directions BD1 and BD2: On beam direction BD1, slots 1, 2 and 3 are available and considered as a candidate resource set associated with the beam direction BD1. On the beam direction BD2, slots 3,4 and 5 are available and considered as a candidate resource set associated to the beam direction BD2.

In one embodiment, if/when the UE needs to select a transmission resource, the UE selects a beam from a candidate beam and selects the resource from the candidate resource associated to the selected beam.

In one embodiment, the UE may not select a beam during resource selection. The UE can determine which beam to be used when MAC PDU is generated. Therefore, the resources associated to the candidate beam can be selected. As an alternative or in addition, when the UE needs to select a transmission resource, the UE selects the resource from the candidate resources associated to the candidate beam. As an alternative or in addition, when the UE needs to select a transmission resource, the UE selects the resource from the candidate resource associated with any candidate beam of a destination (e.g., RX UE) having a logical channel with the highest priority.

In one embodiment, the UE determines the selected transmission resource is a sidelink grant or selected grant or selected sidelink grant.

In one embodiment, after selecting the transmission resource, the UE needs to allocate the transmission resource. In response to the UE needing to select a destination for resource allocation, the UE selects the destination (e.g., if the beam of the sidelink grant is one candidate beam of the destination.

The beam of the sidelink grant is the beam of the transmission resource selected from the resource set of the beam. For example, the transmission resource 1 is selected from the resource set(1, 2, 3) of beam 1, and the transmission resource-1 is considered as a selected sidelink grant, then the beam 1 is the beam of the sidelink grant.

In one embodiment, in response to the UE needing to select a destination for resource allocation, the UE selects the destination if the measurement result received from the destination UE of beam of the sidelink grant is higher than the beam selection threshold. For example, UE select the transmission resource-1 from resource set of beam-1, and considers the selected transmission resource as grant. Then the beam of sidelink grant is on the beam direction BD1. For a destination-1, the measurement result of the beam on the beam direction BD1 is 53 which is higher than the beam selection threshold=38. The destination-1 can be selected. For the destination-2, the measurement result of the beam on the beam direction BD2 on is 20 which is smaller than the beam selection threshold=38. Thus, the destination-2 should not be selected.

In one embodiment, the peer destination UE may only report the beam with the measurement result higher than the measurement result report threshold. If the UE needs to select a destination (UE) for the resource allocation, the UE selects the destination (UE) if the beam of the sidelink grant is within the beam list reported by the destination (UE). For example, the transmission resource (1) is selected from the resource set(1, 2, 3) of a beam-1 and considered as the selected sidelink grant. The destination UE-1 measures the beam-1 and determines not to include the beam-1 in the measurement report since the measurement result of the beam-1 is lower than the measurement result report threshold. In other words, the beam measurement report may only include (beam 2, 3, 4). During the destination selection for the destination UE-1, since the selected beam-1 is not within the beam list (2, 3, 4) reported by the destination UE-1, the destination UE-1 should not be selected. For a destination UE-2, the beam list (1, 2, 3) is reported. During destination selection, since the selected beam-1 is within the beam list (1, 2, 3) reported by the destination UE-2, the destination UE-2 can be selected.

In one embodiment, the UE may have a power saving requirement. To save the power, the UE may performs Discontinuous Reception (DRX). Specifically, the UE only monitors the channel for reception in an active time of the DRX, wherein the active time is a time duration. The active time includes at least one of following:
1. the time between the transmission of discovery message and the reception of discovery response message;
2. the time between the transmission of the beam failure recovery message and the reception of beam failure recovery response message;
3. the time between a time of the beam failure being detected and a time of beam failure recovery procedure being completed; or
4. the time between a time of the beam failure recovery procedure being started and a time of beam failure recovery procedure being completed.

### Sidelink Relay DRX (Discontinuous Reception)

In an embodiment, the UE considers it is in an active time of the Sidelink relay DRX if a discovery message is transmitted and a response message is received.

In an embodiment, the UE considers it is in the active time of the Sidelink relay DRX if a beam failure is detected. In this embodiment, the UE considers it is not in the active time of the Sidelink relay DRX after the beam failure is recovered.

In an embodiment, the UE detects a failure on an indirect path to a destination (e.g., second wireless communication device) and cannot transmit SRB1 to the destination, the UE applies a default SRB configuration on a Uu path with the destination and performs the transmission via the Uu interface/path.

In an embodiment, the indirect path refers to a path on which the first wireless communication device communicates with the second wireless communication device via the third wireless communication device (e.g., relay (terminal).

FIG. 4 shows a flowchart diagram if two user devices communicating with each other according to an embodiment of the present disclosure. In FIG. 4, the second user device transmits a dedicated configuration for a sidelink communication to the first user device. The first user device performs the sidelink communication according to the dedicated configuration. The second user device in FIG. 4 may be a network node (e.g., BS).

In an embodiment, the dedicated configuration is for a standalone signal.

In an embodiment, the standalone signaling comprises at least one of a beam RS, sidelink control information, or a request of the beam RS measurement.

In an embodiment, the beam RS may be CSI (channel state information) RS, an SRS (sounding reference signal) or a sidelink SSB (synchronization signal/physical broadcast channel block).

In an embodiment, the first user device (e.g., TX UE) sends at least one of the following standalone signaling transmission information to the second user device (e.g., network) and receive a sidelink grant (e.g., dedicated configuration) for the standalone signaling from the second user device network:
1. a period of the standalone signaling;
2. a latency bound of the standalone signaling;
3. a resource scheduling requesting of the standalone signaling.

In an embodiment, standalone signaling transmission information is included in at least one of: an RRC signaling, a MAC CE (media access control control element), or a buffer status report MAC CE,

In an embodiment, the second user device sends at least one of the following configurations of standalone signaling to the first user device and the first user device sends the standalone signaling (e.g., to another user device):
1. priority of standalone signaling
2. scheduling request ID indicating the scheduling request configuration applicable for standalone signaling
3. LCID of standalone signaling
4. logical channel group of standalone signaling.

In an embodiment, if the first user device does not has resources for transmitting the standalone signaling, the first user device triggers a scheduling request.

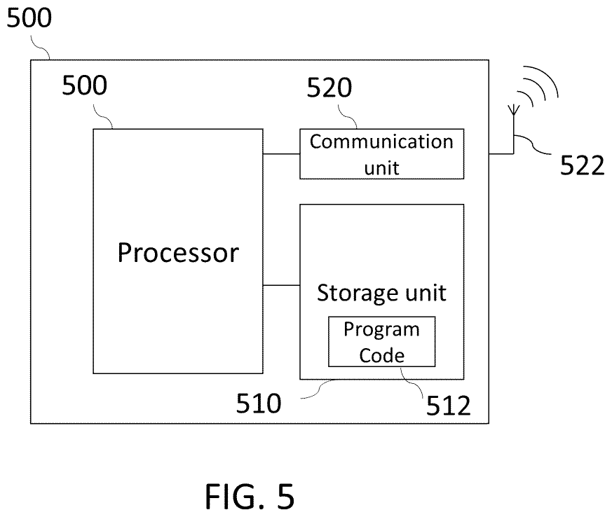

FIG. 5 relates to a schematic diagram of a wireless terminal 50 according to an embodiment of the present disclosure. The wireless terminal 50 may be a user equipment (UE), a mobile phone, a laptop, a tablet computer, an electronic book or a portable computer system and is not limited herein. The wireless terminal 50 may include a processor 500 such as a microprocessor or Application Specific Integrated Circuit (ASIC), a storage unit 510 and a communication unit 520. The storage unit 510 may be any data storage device that stores a program code 512, which is accessed and executed by the processor 500. Embodiments of the storage unit 510 include but are not limited to a subscriber identity module (SIM), read-only memory (ROM), flash memory, random-access memory (RAM), hard-disk, and optical data storage device. The communication unit 520 may a transceiver and is used to transmit and receive signals (e.g., messages or packets) according to processing results of the processor 500. In an embodiment, the communication unit 520 transmits and receives the signals via at least one antenna 522 shown in FIG. 5.

In an embodiment, the storage unit 510 and the program code 512 may be omitted and the processor 500 may include a storage unit with stored program code.

The processor 500 may implement any one of the steps in exemplified embodiments on the wireless terminal 50, e.g., by executing the program code 512.

The communication unit 520 may be a transceiver. The communication unit 520 may as an alternative or in addition be combining a transmitting unit and a receiving unit configured to transmit and to receive, respectively, signals to and from a wireless network node (e.g., a base station).

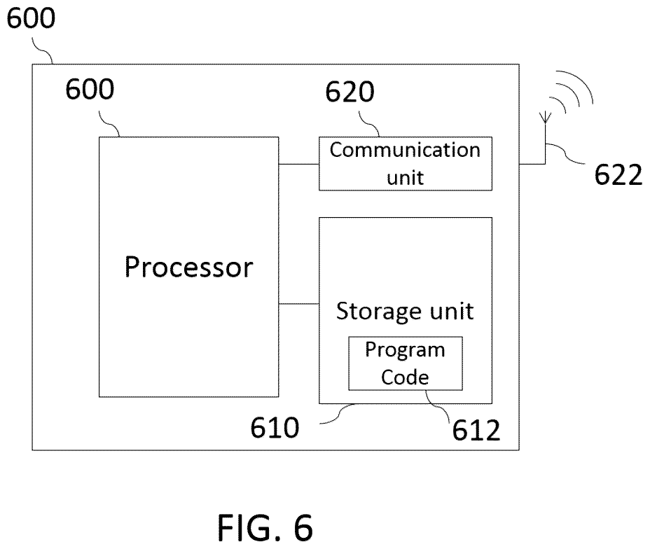

FIG. 6 relates to a schematic diagram of a wireless network node 60 according to an embodiment of the present disclosure. The wireless network node 60 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 60 may comprise (perform) at least one network function such as an access and mobility management function (AMF), a session management function (SMF), a user place function (UPF), a policy control function (PCF), an application function (AF), etc. The wireless network node 60 may include a processor 600 such as a microprocessor or ASIC, a storage unit 610 and a communication unit 620. The storage unit 610 may be any data storage device that stores a program code 612, which is accessed and executed by the processor 600. Examples of the storage unit 610 include but are not limited to a SIM, ROM, flash memory, RAM, hard-disk, and optical data storage device. The communication unit 620 may be a transceiver and is used to transmit and receive signals (e.g., messages or packets) according to processing results of the processor 600. In an example, the communication unit 620 transmits and receives the signals via at least one antenna 622 shown in FIG. 6.

In an embodiment, the storage unit 610 and the program code 612 may be omitted. The processor 600 may include a storage unit with stored program code.

The processor 600 may implement any steps described in exemplified embodiments on the wireless network node 60, e.g., via executing the program code 612.

The communication unit 620 may be a transceiver. The communication unit 620 may as an alternative or in addition be combining a transmitting unit and a receiving unit configured to transmit and to receive, respectively, signals to and from a wireless terminal (e.g., a user equipment or another wireless network node).

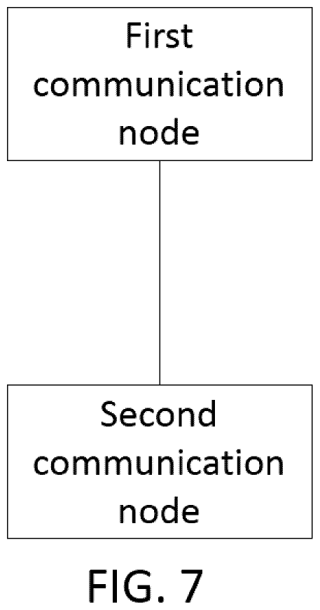

FIG. 7 shows a schematic diagram of a network/system (architecture) according to an embodiment of the present disclosure. In FIG. 7, the first communication node communicates with the second communication node. For example, the first communication node and the second communication node may respectively be the first user device and the second user device shown in FIG. 1. The first communication node may directly communicate with the second communication node. As an alternative or in addition, the first communication node may communicate with the second communication node via a relay terminal (not shown in FIG. 7). For example, the relay terminal may be a UE.

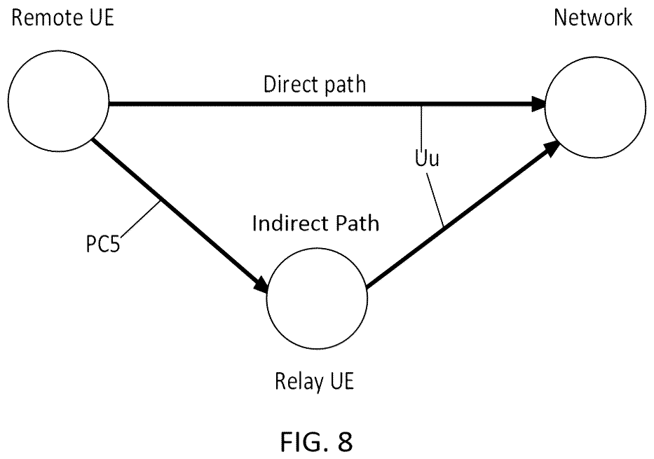

FIG. 8 shows a schematic diagram of a direct path and an indirect path according to an embodiment of the present disclosure.

In FIG. 8, the UE (e.g., remote UE) may connect with the network via multiple paths. One path is called direct path: the UE directly connects to/accesses/communicates with network. Another path is called indirect path: the UE connect with network via a relay UE. The UE connects to relay UE via a sidelink interface (e.g., sidelink interface).

When/If the UE has not connected to the network (e.g., the UE is in an RRC IDLE or RRC INACTIVE state), the UE can connect with the network via either the direct path or the indirect path. After connecting to network, the network can add another path to the UE. For example, the UE may initiate the connection with the network via the direct path and the network may add the indirect path to (communicate with) the UE. As an alternative, the UE initiates the connection with network via the indirect path, and the network adds the direct path to the UE.

For each radio bearer (RB) of the UE, each RB can be configured on the direct path or the indirect path or both (i.e., multiple paths) the direct and indirect paths. In other words, the RB type can be direct path RB, indirect path RB, or multiple path RB. For the direct path RB, the RB is configured with a Uu RLC (radio link control) configuration. For the indirect path RB, the RB is configured with a sidelink RLC configuration. For multiple path bearer, the RB is configured with both the Uu RLC configuration and the sidelink RLC configuration.

Upon/after the connection of one path is failure due to at least one of radio link failure, beam failure, or listen before talk failure, the UE can report the failure information via another path. For example, if the direct path is failed, the UE reports the failure information via the indirect path. If the indirect path is failed, the UE reports the failure information via the direct path.

In one embodiment, the failure information can only be transmitted via a specific RB, e.g., SRB1 (Signalling Radio Bearer 1).

If the specific RB is the indirect path bearer and if the indirect path is failed, the UE changes the RB type of this RB from the indirect path bearer to the direct path bearer, applies the default sidelink RLC configuration for this specific RB and transmits the failure information to network.

If the specific RB is the direct path bearer and if the direct path is failed, the UE changes the RB type of this RB from the direct path bearer to the indirect path bearer, applies the default Uu RLC configuration for this specific RB and transmits the failure information to the network.

In one embodiment, when the UE (e.g., remote UE) connects to the network via the indirect path (i.e., via relay UE), the relay UE needs to be configured with an RLC configuration. The RLC configuration is used for relay UE to forward the packet of the remote UE. To allow the relay UE to differentiate the received RLC bearer belongs to the remote UE or the relay UE, the RLC configuration includes an first indication. After receiving the RLC configuration with the remote UE indication, the relay UE determines that this RLC configuration is used for forwarding the traffic/data of the remote UE. In one embodiment, the UE receives at least one of following first indication from network: remote UE indication, remote UE ID, indirect path indication, relay UE indication, relay UE ID, direct path indication, UE aggregation indication. In one embodiment, the first indication is included in the RLC configuration.

In one embodiment, the UE receives the Channel Occupancy Time (COT) sharing information including shared COT from peer UE. The COT is a consecutive or non-consecutive time duration occupied by performing listen before talk. It is possible that the selected transmission resource is not within the shared COT. To utilize the COT sharing information as much as possible, if the selected transmission resource is not within the shared COT, the UE may trigger a resource re-selection. For example, if all selected transmission resources is not within the shared COT, or there is candidate resource which is not selected and this candidate resource is within the shared COT, the UE may trigger the resource re-selection. The selected transmission resource is considered as a selected grant.

In one embodiment, if no selected transmission resource is within the shared COT, the UE triggers the resource re-selection.

In one embodiment, if there are no resources within the intersection of the sensing results of the UE and the COT shared by peer UE, the UE selects the transmission resource from its own sensing results.

In one embodiment, if there are no resources within the intersection of the sensing results of the UE and the COT obtained by the UE, the UE selects the transmission resource from the sensing results.

In one embodiment, if the candidate resource is available and is within the shared COT, UE shall trigger resource re-selection.

In one embodiment, if any selected transmission resources is not within the shared COT, UE shall trigger resource re-selection.

In an embodiment, the sensing results comprise a set of candidate resource set determined by the UE.

In one embodiment, except the COT sharing, the UE obtains a COT by performing a type1 listen before talk. If the selected transmission resource is not within the obtained COT, the UE triggers the resource re-selection. As an alternative, if all selected transmission resources are not within the obtained COT, the UE triggers the resource re-selection. As an alternative, if all selected transmission resources are not within the obtained COT, the UE shall trigger resource re-selection. As an alternative, if no selected transmission resource is within the obtained COT, the UE shall trigger resource re-selection. Optionally, if the candidate resource is available and is within the obtained COT, the UE shall trigger resource re-selection. Optionally, if any selected transmission resource is not within the obtained COT, the UE shall trigger resource re-selection.

In one embodiment, if negative-only acknowledgement was enabled and no negative acknowledgement was received for the transmission of MAC PDU, the UE considers the remaining transmission resources of this MAC PDU as transmission resource of another MAC PDU.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1.-60. (canceled)

61. A wireless communication method for use in a first wireless communication device, the method comprising:
determining at least one beam selection condition associated with a second wireless communication device is met, and
triggering a beam selection process for the second wireless communication device.

62. The wireless communication method of claim 61, wherein the at least one beam selection condition comprises at least one of:
a resource re-selection is triggered,
a beam measurement result associated with the second wireless communication device is lower than a beam re-selection threshold,
a selected beam for the second wireless communication device is within a non-preferred beam list received from the second wireless communication device,
a maximum number of consecutive hybrid automatic repeated request discontinuous transmissions has been reached, or
a maximum number of consecutive physical sidelink feedback channel absences has been reached.

63. The wireless communication method of claim 61, wherein the triggering the beam selection process for the second wireless communication device comprises at least one of:
determining all beams are candidate beams,
determining a beam reported by the second wireless communication device as one of the candidate beams,
determining a first beam having a first measurement result above a beam selection threshold as one of the candidate beams,
excluding a second beam having a second measurement result below the beam selection threshold from the candidate beams,
excluding at least one non-preferred beam received from the second wireless communication device from the candidate beams,
selecting a beam from preferred beams received from the second wireless communication device,
selecting a beam from recommended beams received from the second wireless communication device,
selecting a beam from the candidate beams,
selecting a beam from a preferred beam list received from the second wireless communication device, or
selecting a beam from at least one overlapping beam which is in the candidate beams and the preferred beam list received from the second wireless communication device.

64. A wireless communication method for use in a first wireless communication device, the method comprising:
selecting a transmission resource for a sidelink communication, and
allocating the transmission resource for the sidelink communication.

65. The wireless communication method of claim 64, wherein the selecting the transmission resource for the sidelink communication comprises at least one of:
selecting a beam from at least one candidate beam and selecting the transmission resource from transmission resources associated with the selected beam, or
selecting the transmission resource from transmission resources associated with the at least one candidate beam.

66. The wireless communication method of claim 64, wherein the selected transmission resource is a sidelink grant, and wherein the allocating the transmission resource for the sidelink communication comprises:
selecting a destination wireless communication device if a beam associated with the sidelink grant is within a candidate beam list of the destination wireless communication device,
selecting the destination wireless communication device if a measurement result of the beam associated with the sidelink grant is greater than a beam selection threshold of the destination wireless communication device, or
selecting the destination wireless communication device if the beam of the sidelink grant is within a beam list reported by the destination wireless communication device.

67. A first wireless communication device, comprising:
one or more processors configured to:
determine at least one beam selection condition associated with a second wireless communication device is met, and
trigger a beam selection process for the second wireless communication device.

68. The first wireless communication device of claim 67, wherein the at least one beam selection condition comprises at least one of:
a resource re-selection is triggered,
a beam measurement result associated with the second wireless communication device is lower than a beam re-selection threshold,
a selected beam for the second wireless communication device is within a non-preferred beam list received from the second wireless communication device,
a maximum number of consecutive hybrid automatic repeated request discontinuous transmissions has been reached, or
a maximum number of consecutive physical sidelink feedback channel absences has been reached.

69. The first wireless communication device of claim 67, wherein the triggering the beam selection process for the second wireless communication device comprises at least one of:
determining all beams are candidate beams,
determining a beam reported by the second wireless communication device as one of the candidate beams,
determining a first beam having a first measurement result above a beam selection threshold as one of the candidate beams,
excluding a second beam having a second measurement result below the beam selection threshold from the candidate beams,
excluding at least one non-preferred beam received from the second wireless communication device from the candidate beams,
selecting a beam from preferred beams received from the second wireless communication device,
selecting a beam from recommended beams received from the second wireless communication device,
selecting a beam from the candidate beams,
selecting a beam from a preferred beam list received from the second wireless communication device, or
selecting a beam from at least one overlapping beam which is in the candidate beams and the preferred beam list received from the second wireless communication device.

70. A first wireless communication device, comprising one or more processors configured to:
select a transmission resource for a sidelink communication, and
allocate the transmission resource for the sidelink communication.

71. The first wireless communication device of claim 70, wherein the selecting the transmission resource for the sidelink communication comprises at least one of:
selecting a beam from at least one candidate beam and selecting the transmission resource from transmission resources associated with the selected beam, or
selecting the transmission resource from transmission resources associated with the at least one candidate beam.

72. The first wireless communication device of claim 70, wherein the selected transmission resource is a sidelink grant, and wherein the allocating the transmission resource for the sidelink communication comprises:
selecting a destination wireless communication device if a beam associated with the sidelink grant is within a candidate beam list of the destination wireless communication device,
selecting the destination wireless communication device if a measurement result of the beam associated with the sidelink grant is greater than a beam selection threshold of the destination wireless communication device, or
selecting the destination wireless communication device if the beam of the sidelink grant is within a beam list reported by the destination wireless communication device.

73. A computer program product comprising a computer-readable program medium code stored thereupon, the code, when executed by one or more processors, causing the one or more processors to implement a wireless communication method comprising:
determining at least one beam selection condition associated with a second wireless communication device is met, and
triggering a beam selection process for the second wireless communication device.

74. A computer program product comprising a computer-readable program medium code stored thereupon, the code, when executed by one or more processors, causing the one or more processors to implement a wireless communication method comprising:
selecting a transmission resource for a sidelink communication, and
allocating the transmission resource for the sidelink communication.
